(19) United States
(12) Patent Application Publication
(10) Pub. No.: US 2017/0247526 A1
(43) Pub. Date: Aug. 31, 2017

(54) BLOW MOLDING COMPOSITION AND PROCESS

(71) Applicant: NOVA Chemicals (International) S.A., Fribourg (CH)

(72) Inventors: Matthew Botros, Calgary (CA); Owen Lightbody, Calgary (CA); Fraser Waldie, Calgary (CA); Gilbert Arnould, Calgary (CA); Tony Tikuisis, Calgary (CA); Anna Rajkovic, Coldstream (CA)

(73) Assignee: NOVA Chemicals (International) S.A., Fribourg (CH)

(21) Appl. No.: 15/521,627

(22) PCT Filed: Oct. 28, 2015
(86) PCT No.: PCT/IB2015/058318

§ 371 Date: Apr. 25, 2017

(30) Foreign Application Priority Data
Nov. 7, 2014 (CA) 2870027

(51) Int. Cl. C08K 5/098; B29C 49/00; B65D 1/02; C08J 5/00

(52) U.S. Cl. CPC C08K 5/098; C08J 5/00; B29C 49/0005; B65D 1/0207; C08J 2323/08; B29K 2023/08

(57) ABSTRACT

This invention provides a blow molding composition comprising a high molecular weight, chromium catalyzed ethylene copolymer (also referred to as a polyethylene resin) and a nucleating agent. The composition enables a more efficient blow molding process by reducing the number of malformed/rejected parts that are produced when the process is operated at high rates. In a preferred embodiment, the malformed parts may be reground and added to “virgin” composition for the production of prime parts.

### TECHNICAL FIELD

This invention relates to the blow molding of polyethylene.

### BACKGROUND ART

Blow molding is in wide spread commercial use for the manufacture of hollow plastic parts such as bottles, storage tanks and toys.

Polypropylene, polyethylene terphthalate (PET) and polyethylene are commonly used in blow molding operations.

The use of nucleating agents in blow molding processes is known—see for example U.S. Pat. No. 6,153,715.

### DISCLOSURE OF THE INVENTION

In one embodiment, the present invention provides:

a blow molding composition comprising

A) a chromium catalyzed ethylene copolymer having
i) a high load melt index, as measured by ASTM 1238 at 190° C. using a 21.6 kg load, of from 2 to 10 grams/10 minutes;
ii) a density of from 0.944 to 0.955 g/cc;
iii) a crystallization half time of greater than 20 minutes when measured at 125° C. and in the absence of a nucleating agent; and

B) from 100 to 5000 ppm of nucleating agent,

wherein the crystallization half time of the composition containing the nucleating agent is at least 10% lower than the crystallization half time of the non nucleated copolymer (A).

In another embodiment, the present invention provides:

a method for improving the dimensional stability of blow molded polyethylene parts, said method comprising:

a blow molding composition comprising

A) a chromium catalyzed ethylene copolymer having
i) a high load melt index, as measured by ASTM 1238 at 190° C. using a 21.6 kg load, of from 2 to 10 grams/10 minutes;
ii) a density of from 0.946 to 0.955 g/cc;
iii) a crystallization half time of greater than 20 minutes when measured at 125° C. and in the absence of a nucleating agent; and

B) from 100 to 5000 ppm of nucleating agent,

wherein the crystallization half time of the composition containing the nucleating agent is at least 10% lower than the crystallization half time of the non nucleated copolymer (A).

### BEST MODE FOR CARRYING OUT THE INVENTION

### Part A: Cr Catalyzed Resin

The polyethylene used in this invention is prepared with a chromium catalyst. The chromium catalyst may be a chromium oxide (i.e. CrO₃) or any compound convertible to chromium oxide. For compounds convertible to chromium oxide see U.S. Pat. Nos. 2,825,721; 3,023,203; 3,622,251; and 4,011,382. Compounds convertible to chromium oxide include for example, chromic acetyl acetone, chromic chloride, chromic nitrate, chromic acetate, chromic sulfate, ammonium chromate, ammonium dichromate, and other soluble chromium containing salts.

The chromium catalyst may be a silyl chromate catalyst. Silyl chromate catalysts are chromium catalysts which have at least one group of the formula:

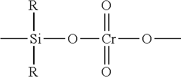

wherein R is independently a hydrocarbon group having from 1 to 14 carbon atoms.

The silyl chromate catalyst may also be a bis(silyl)chromate catalyst which has the formula:

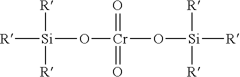

wherein R′ is independently a hydrocarbon group having from 1 to 14 carbon atoms.

R or R′ can independently be any type of hydrocarbyl group such as an alkyl, alkylaryl, arylalkyl or an aryl radical. Some non-limiting examples of R or R′ include methyl, ethyl, propyl, iso-propyl, n-butyl, iso-butyl, n-pentyl, iso-pentyl, t-pentyl, hexyl, 2-methyl-pentyl, heptyl, octyl, 2-ethylhexyl, nonyl, decyl, hendecyl, dodecyl, tridecyl, tetradecyl, benzyl, phenethyl, p-methyl-benzyl, phenyl, tolyl, xylyl, naphthyl, ethylphenyl, methylnaphthyl, dimethylnaphthyl, and the like.

Illustrative of preferred silyl chromates but by no means exhaustive or complete of those that can be employed in the present invention are such compounds as bis-trimethylsilylchromate, bis-triethylsilylchromate, bis-tributylsilylchromate, bis-triisopentylsilylchromate, bis-tri-2-ethyl hexylsilylchromate, bis-tridecylsilylchromate, bis-tri(tetradecyl)silylchromate, bis-tribenzylsilylchromate, bis-triphenethylsilylchromate, bis-triphenylsilylchromate, bis-tritolylsilylchromate, bis-trixylylsilylchromate, bis-trinaphthylsilylchromate, bis-triethylphenylsilylchromate, bis-trimethylnaphthylsilylchromate, polydiphenylsilylchromate, polydiethylsilylchromate and the like. Examples of bis-trihydrocarbylsilylchromate catalysts are also disclosed in U.S. Pat. Nos. 3,704,287 and 4,100,105.

The chromium catalyst may also be a mixture of chromium oxide and silyl chromate catalysts.

The polyethylene used in the present invention may be prepared with chromocene catalysts (see for example U.S. Pat. Nos. 4,077,904 and 4,115,639) and chromyl chloride (e.g. CrO₂Cl₂) catalysts. Additionally, the polyethylene may be prepared with a “titanated” chromium catalyst which may be prepared by co-supporting a chromium compound (such as CrCl₃) and a titanium compound (such as titanium tetra butoxide), followed by activation in dry air at elevated temperatures (as disclosed, for example, in U.S. Pat. No. 5,166,279, Speakman; assigned to BP).

The chromium catalysts described above, may be immobilized on an inert support material, such as for example an inorganic oxide material. Suitable inorganic oxide supports are composed of porous particle materials having a spheroid shape and a size ranging from about 10 micrometers to about 200 micrometers (μm). The particle size distribution can be broad or narrow. The inorganic oxide typically will have a surface area of at least about 100 m²/g, preferably from about 150 to 1,500 m²/g. The pore volume of the inorganic oxide support should be at least 0.2, preferably from about 0.3 to 5.0 mL/g. The inorganic oxides may be selected from group 2, 3, 4, 5, 13 and 14 metal oxides generally, such as silica, alumina, silica-alumina, magnesium oxide, zirconia, titania, and mixtures thereof. The use of clay (e.g. montmorillonite) and magnesium chloride as support materials is also contemplated.

When the inorganic oxide is a silica support, it will preferably contain not less than 80% by weight of pure SiO₂, with the balance being other oxides such as but not limited to oxides of Zr, Zn, Mg, Ti, Mg and P.

Generally, the inorganic oxide support will contain acidic surface hydroxyl groups that will react with a polymerization catalyst. Prior to use, the inorganic oxide may be dehydrated to remove water and to reduce the concentration of surface hydroxyl groups. For example, the inorganic oxide may be heated at a temperature of at least 200° C. for up to 24 hours, typically at a temperature of from about 500° C. to about 800° C. for about 2 to 20 hours, preferably 4 to 10 hours. The resulting support will be free of adsorbed water and should have a surface hydroxyl content from about 0.1 to 5 mmol/g of support, preferably from 0.5 to 3 mmol/g.

Although heating is the preferred means of removing surface hydroxyl groups present in inorganic oxides, such as silica, the hydroxyl groups may also be removed by other removal means, such as chemical means. For example, a desired proportion of OH groups may be reacted with a suitable chemical agent, such as a hydroxyl reactive aluminum compound (e.g. triethylaluminum) or a silane compound. (See: U.S. Pat. No. 4,719,193 to Levine).

A silica support that is suitable for use in the present invention has a high surface area and is amorphous. By way of example, useful silicas are commercially available under the trademark of Sylopol® 958, 955 and 2408 from Davison Catalysts, a Division of W. R. Grace and Company and ES-70W™ from Ineos Silica.

The amount of chromium catalyst added to the support should be sufficient to obtain between 0.01% and 10%, preferably from 0.1% to 3%, by weight of chromium, calculated as metallic chromium, based on the weight of the support.

Processes for depositing chromium catalysts on supports are well known in the art (for some non-limiting methods for supporting chromium catalysts see U.S. Pat. Nos. 6,982,304; 6,013,595; 6,734,131; 6,958,375; and European Pat. No. 640,625). For example, the chromium catalyst may be added by co-precipitation with the support material or by spray-drying with the support material. The chromium catalyst may also be added by a wet incipient method (i.e. wet impregnation) or similar methods using hydrocarbon solvents or other suitable diluents. Alternatively, the supported chromium catalyst may be obtained by the mechanical mixing of a solid chromium compound with a support material, followed by heating the mixture. In another variation, the chromium compound may be incorporated into the support during the manufacture thereof so as to obtain a homogeneous dispersion of the metal in the support. In a typical method, a chromium catalyst is deposited on a support from solutions of the chromium catalyst and in such quantities as to provide, after an activation step (if required, see below), the desired levels of chromium on the support.

The chromium catalyst may require activation prior to use. Activation may involve calcination (as is preferred in the case of chromium oxide) or the addition of a co-catalyst compound (as is preferred in the case of silyl chromate).

Activation by calcination can be accomplished by heating the supported chromium catalyst in steam, dry air or another oxygen containing gas at temperatures up to the sintering temperature of the support. Activation temperatures are typically in the range of 300° C. to 950° C., preferably from 500° C. to 900° C. and activation times are typically from about 10 minutes to as about 72 hours. The chromium catalyst may optionally be reduced after activation using for example, carbon monoxide or a mixture of carbon monoxide and nitrogen.

The supported chromium catalysts may optionally comprise one or more than one co-catalyst and mixtures thereof. The co-catalyst can be added to the support or the supported chromium catalyst using any well-known method. Hence, the co-catalyst and chromium catalyst can be added to the support in any order or simultaneously. Alternatively, the co-catalyst can be added to the supported chromium catalyst in situ. By way of a non-limiting example, the co-catalyst is added as a solution or slurry in hydrocarbon solvent to the supported chromium catalyst which is optionally also in hydrocarbon solvent.

Co-catalysts include compounds represented by formula:

M*R²ₙ

where M* represents an element of the Group 1, 2 or 13 of the Periodic Table, a tin atom or a zinc atom; and each R² independently represents a hydrogen atom, a halogen atom (e.g. chlorine fluorine, bromine, iodine and mixtures thereof), an alkyl group (e.g. methyl, ethyl, propyl, pentyl, hexyl, heptyl, octyl, decyl, isopropyl, isobutyl, s-butyl, t-butyl), an alkoxy group (e.g. methyoxy, ethoxy, propoxy, butoxy, isopropoxy), an aryl group (e.g. phenyl, biphenyl, naphthyl), an aryloxy group (e.g. phenoxy), an arylalkyl group (e.g. benzyl, phenylethyl), an arylalkoxy group (benzyloxy), an alkylaryl group (e.g. tolyl, xylyl, cumenyl, mesityl), or an alkylaryloxy group (e.g. methylphenoxy), provided that at least one R² is selected from a hydrogen atom, an alkyl group having 1 to 24 carbon atoms or an aryl, arylalkyl or alkylaryl group having 6 to 24 carbon atoms; and n is the oxidation number of M*.

Preferred co-catalysts are organoaluminum compounds having the formula:

Al²(X¹)ₙ(X²)₃₋ₙ,

where (X¹) is a hydrocarbyl having from 1 to about 20 carbon atoms; (X²) is selected from alkoxide or aryloxide, any one of which having from 1 to about 20 carbon atoms; halide; or hydride; and n is a number from 1 to 3, inclusive. Specific examples of (X¹) moieties include, but are not limited to, ethyl, propyl, n-butyl, sec-butyl, isobutyl, hexyl, and the like. In another aspect, (X²) may be independently selected from fluoro or chloro. The value of n is not restricted to be an integer, therefore this formula includes sesquihalide compounds or other organoaluminum cluster compounds.

Some non-limiting examples of aluminum co-catalyst compounds that can be used include, but are not limited to, trialkylaluminum compounds, dialkylaluminum halide compounds, dialkylaluminum alkoxide compounds, dialkylaluminum hydride compounds, and combinations thereof. Specific examples of organoaluminum co-catalyst compounds that are useful in this invention include, but are not limited to: trimethylaluminum (TMA); triethylaluminum (TEA); triisopropylaluminum; diethylaluminum ethoxide; tributylaluminum; disobutylaluminum hydride; triisobutylaluminum; and diethylaluminum chloride.

The supported chromium catalyst may be combined with mineral oil in an amount which does not form a slurry of the supported chromium catalyst in the mineral oil.

The term “mineral oil” as used herein refers to petroleum hydrocarbons and mixtures of hydrocarbons that may include aliphatic, napthenic, aromatic, and/or paraffinic components that are viscous liquids at 23° C. and preferably have a dynamic viscosity of at least 40 centiPoises (cP) at 40° C. or a kinematic viscosity of a least 40 centistokes (cSt) at 40° C.

There are three basic classes of refined mineral oils including paraffinic oils based on n-alkanes; napthenic oils based on cycloalkanes; and aromatic oil based on aromatic hydrocarbons. Mineral oils are generally a liquid by-product of the distillation of petroleum to produce gasoline and other petroleum based products from crude oil. Hence, mineral oils may be, for example, light, medium or heavy oils coming from the distillation of coal tars or oils obtained during the fractional distillation of petroleum. Mineral oil obtained from petroleum sources (i.e. as a distillate product) will have a paraffinic content, naphthenic content and aromatic content that will depend on the particular type of petroleum used as a source material.

Mineral oils may have a molecular weight of at least 300 amu to 500 amu or more, and a kinematic viscosity at 40° C. of from 40 to 300 centistokes (cSt, note: 1 cSt=1 mm²/s) or greater.

A mineral oil may be a transparent, colourless oil composed mainly of alkanes (typically 15 to 40 carbons) and cyclic paraffins related to petroleum jelly.

Mineral oils may be oils which are hydrocarbon mixtures distilling from about 225° C. to about 400° C. Typical examples of such mineral oils are the ONDINA® 15 to 68 oils sold by Shell or their equivalents.

The term “mineral oil” includes synthetic oils and other commercial oils such as paraffin oils sold under such names as KAYDOL® (or White Mineral Oil), ISOPAR®, STRUKTOL®, SUNPAR® oils, PARAPOL® oils, and other synthetic oils, refined naphthenic hydrocarbons, and refined paraffins known in the art.

Preferably the mineral oil is substantially free of impurities which may negatively affect the chromium catalyst activity or performance. Hence, it is preferably to use relatively pure mineral oil (i.e. greater than 95 percent pure or greater than 99 percent pure). Suitable mineral oils include KAYDOL, HYDROBRITE® 550, and HYDROBRITE 1000 available from Crompton Chemical Corporation.

The mineral oil may be a hydrocarbon mineral oil which is viscous and comprises primarily aliphatic hydrocarbons oils. Examples of suitable mineral oils include paraffinic/naphthenic oils such as those sold under the names KAYDOL, SHELLFLEX® 371 and TUFFLO® 6000.

The mineral oil may also be a mixture or blend of two or more mineral oils in various concentrations.

Silicon oils are also suitable.

Preferred mineral and silicon oils useful in the present invention are those that exclude moieties that are reactive with chromium catalysts, examples of which include hydroxyl and carboxyl groups.

The methods for adding a mineral oil to the chromium catalyst are not limited but it is preferred that the resulting catalyst be in the form of a solid powder, preferably a free flowing powder, and which is not a slurry of solid catalyst in mineral oil. Hence, the amount of mineral oil added to a supported chromium catalyst should be less than the amount required to give a slurry of the supported chromium catalyst in mineral oil. Sticky or tacky particulate catalysts are not as easily fed to a polymerization reactor as a dry catalyst powder.

The amount of mineral oil that can be added to a chromium catalyst without forming a slurry can be determined by experiment and will depend on a number of factors such as the type of chromium catalyst used, and especially the type and physical properties of the support on which the chromium catalyst is immobilized.

A supported chromium catalyst may comprise from 1 to 45 weight percent (especially 5 to 40 weight percent) of mineral oil based on the entire weight of the supported chromium catalyst.

One convenient way to combine a mineral oil with a supported chromium catalyst is to combine them in suitable hydrocarbon diluents. Without wishing to be bound by theory, the use of hydrocarbon diluent(s) may assist the mineral oil in penetrating the pores of the catalyst support. As used herein, the term “hydrocarbon diluent(s)” is meant to include any suitable hydrocarbon diluents other than mineral oils (or silicon oils). For example, n-pentane, isopentane, n-hexane, benzene, toluene, xylene, cyclohexane, isobutane and the like can be used as a hydrocarbon diluent. One or more hydrocarbon diluents may be used. A mixture of hydrocarbon diluent(s) and mineral oil may be added to a dry catalyst powder (i.e. the supported chromium catalyst) or to a catalyst powder slurried in a suitable diluent. Stirring or other agitation may be used. Alternatively, a dry catalyst (i.e. the supported chromium catalyst) powder may be added to a mineral oil or a mineral oil/hydrocarbon diluent mixture, either directly or as a slurry in suitable hydrocarbon diluents(s). When the supported chromium catalyst and the mineral oil are combined in the presence of hydrocarbon diluents(s), the hydrocarbon diluents(s) should be subsequently removed. Diluent(s) can be removed by using one or more steps selected from washing, filtration and evaporation steps, but the use of exclusively evaporation steps is preferred so as not to remove the mineral oil component from the supported chromium catalyst. Mineral oil may also be added directly to a dry catalyst powder (i.e. the supported chromium catalyst) or vice versa which may optionally be washed with hydrocarbon diluent(s). The oil may also be sprayed onto the dry catalyst powder or the mineral oil may be stirred/tumbled with the dry catalyst powder.

It is preferable to take a pre-made supported chromium catalyst and subsequently treat it with mineral oil either directly or in the presence of hydrocarbon diluent(s). For example, a mineral oil solution or suspension in a suitable hydrocarbon may be added to a supported chromium catalyst followed by the removal of hydrocarbon using well known methods. Such a technique would be suitable for plant scale process and may employ one or more mixing tanks, and one or more solvent/diluent removal steps.

For example, a blend of a mineral oil and hydrocarbon diluent selected from the group consisting of C₁ to C₁₀ alkanes, C₆ to C₂₀ aromatic hydrocarbons, C₇ to C₂₁ alkyl-substituted hydrocarbons, and mixtures thereof may be added to a supported chromium catalyst followed by removal of the hydrocarbon diluent. In another embodiment, a mineral oil and hydrocarbon diluent selected from the group consisting of C₁ to C₁₀ alkanes, C₆ to C₂₀ aromatic hydrocarbons, C₇ to C₂₁ alkyl-substituted hydrocarbons, and mixtures thereof is added to a supported chromium catalyst followed by removal of the hydrocarbon diluent.

When the mineral oil is blended with a suitable hydrocarbon diluent, the diluents-mineral oil mixture may comprise from 1 to 99 wt %, by weight of mineral oil, preferably at least 5 or at least 10 or at least 15 wt % of mineral oil.

Removal of hydrocarbon diluents by evaporation/drying is well known, but preferably the evaporation is carried out under conditions which do not adversely affect the performance of the chromium catalyst. Hence evaporation or drying is carried out under temperatures which do not cause agglomeration of sticking of the catalyst particles together. Removal of hydrocarbon diluents can be carried out under ambient pressures or reduced pressures. Removal of hydrocarbon diluents can be achieved under ambient temperatures or elevated temperatures, provided that elevated temperatures do not lead to catalyst deactivation or catalyst particle agglomeration/sticking. Hydrocarbon diluents may in some circumstances (i.e. for low boiling hydrocarbons) be “blown off” using an inert gas. The time required to remove the hydrocarbon diluents(s) will preferably be sufficient to provide a supported chromium catalyst in solid form, preferably as free flowing particulate solid or powder.

The mineral oil and/or hydrocarbon diluent(s) may also be treated with a scavenger prior to combination with a chromium catalyst.

The scavenger can be any substance which consumes or deactivates trace impurities or poisons and which adversely affect the activity of the chromium catalyst. Suitable scavengers are well known and include organometallic compounds, such as but not limited to organoaluminum compounds having the formula:

Al⁴(X⁵)ₙ(X⁶)₃₋ₙ,

where (X⁵) is a hydrocarbyl having from 1 to about 20 carbon atoms; (X⁶) is selected from alkoxide or aryloxide, any one of which having from 1 to about 20 carbon atoms; halide; or hydride; and n is a number from 1 to 3, inclusive; or alkylaluminoxanes having the formula:

R³⁰₂Al⁵O(R³⁰Al⁵O)ₘAl⁵R³⁰₂

wherein each R³⁰ is independently selected from the group consisting of C₁₋₂₀ hydrocarbyl radicals and m is from 3 to 50. Preferred scavengers are trialkylaluminum compounds and include triisobutylaluminum, and triethylaluminum.

The chromium catalyst may be added to a polymerization zone using a dry catalyst feeder. Dry catalyst feeders are well known to persons skilled in the art and generally include a loading tube/chamber which is connected to a polymerization reactor and which under positive gas pressure delivers a catalyst “plug” to the reactor zone. The catalyst feeder, typically made of metal may comprise a chamber having a mesh or screen and a metal plate with holes in it and which leads to tubing which carries the dry catalyst into the reactor. The operation is often carried out under a nitrogen atmosphere and the dry catalyst is transferred to the reactor under positive nitrogen pressure.

The supported chromium catalyst may be used in a slurry phase or a gas phase polymerization process to produce the polyethylene used in this invention.

Detailed descriptions of slurry polymerization processes are widely reported in the patent literature. For example, particle form polymerization, or a slurry process where the temperature is kept below the temperature at which the polymer goes into solution is described in U.S. Pat. No. 3,248,179. Other slurry processes include those employing a loop reactor and those utilizing a plurality of stirred reactors in series, parallel, or combinations thereof. Non-limiting examples of slurry processes include continuous loop or stirred tank processes. Further examples of slurry processes are described in U.S. Pat. No. 4,613,484.

Slurry processes are conducted in the presence of a hydrocarbon diluent such as an alkane (including isoalkanes), an aromatic or a cycloalkane. The diluent may also be the alpha olefin comonomer used in copolymerizations. Alkane diluents include propane, butanes (i.e. normal butane and/or isobutane), pentanes, hexanes, heptanes and octanes. The monomers may be soluble in (or miscible with) the diluent, but the polymer is not (under polymerization conditions). The polymerization temperature is preferably from about 5° C. to about 200° C., most preferably less than about 120° C. typically from about 10° C. to 100° C. The reaction temperature is selected so that the ethylene copolymer is produced in the form of solid particles. The reaction pressure is influenced by the choice of diluent and reaction temperature. For example, pressures may range from 15 to 45 atmospheres (about 220 to 660 psi or about 1500 to about 4600 kPa) when isobutane is used as diluent (see for example, U.S. Pat. No. 4,325,849) to approximately twice that (i.e. from 30 to 90 atmospheres—about 440 to 1300 psi or about 3000-9100 kPa) when propane is used (see U.S. Pat. No. 5,684,097). The pressure in a slurry process must be kept sufficiently high to keep at least part of the ethylene monomer in the liquid phase. The reaction typically takes place in a closed loop reactor having an internal stirrer (e.g. an impeller) and at least one settling leg. Catalyst, monomers and diluents are fed to the reactor as liquids or suspensions. The slurry circulates through the reactor and the jacket is used to control the temperature of the reactor. Through a series of let down valves the slurry enters a settling leg and then is let down in pressure to flash the diluent and unreacted monomers and recover the polymer generally in a cyclone. The diluent and unreacted monomers are recovered and recycled back to the reactor.

A gas phase process is commonly carried out in a fluidized bed reactor. Such gas phase processes are widely described in the literature (see for example U.S. Pat. Nos. 4,543,399, 4,588,790, 5,028,670, 5,317,036, 5,352, 749, 5,405,922, 5,436,304, 5,453,471, 5,462,999, 5,616,661 and 5,668,228). In general, a fluidized bed gas phase polymerization reactor employs a “bed” of polymer and catalyst which is fluidized by a flow of monomer, comonomer and other optional components which are at least partially gaseous. Heat is generated by the enthalpy of polymerization of the monomer (and comonomers) flowing through the bed. Un-reacted monomer, comonomer and other optional gaseous components exit the fluidized bed and are contacted with a cooling system to remove this heat. The cooled gas stream, including monomer, comonomer and optional other components (such as condensable liquids), is then re-circulated through the polymerization zone, together with “make-up” monomer (and comonomer) to replace that which was polymerized on the previous pass. Simultaneously, polymer product is withdrawn from the reactor. As will be appreciated by those skilled in the art, the “fluidized” nature of the polymerization bed helps to evenly distribute/mix the heat of reaction and thereby minimize the formation of localized temperature gradients.

The reactor pressure in a gas phase process may vary from about atmospheric to about 600 psig. In a more specific embodiment, the pressure can range from about 100 psig (690 kPa) to about 500 psig (3448 kPa). In another more specific embodiment, the pressure can range from about 200 psig (1379 kPa) to about 400 psig (2759 kPa). In yet another more specific embodiment, the pressure can range from about 250 psig (1724 kPa) to about 350 psig (2414 kPa).

The reactor temperature in a gas phase process may vary according to the heat of polymerization as described above. In a specific embodiment, the reactor temperature can be from about 30° C. to about 130° C. In another specific embodiment, the reactor temperature can be from about 60° C. to about 120° C. In yet another specific embodiment, the reactor temperature can be from about 70° C. to about 110° C. In still yet another specific embodiment, the temperature of a gas phase process can be from about 70° C. to about 100° C.

The fluidized bed process described above is well adapted for the preparation of polyethylene homopolymer from ethylene alone, but other monomers (i.e. comonomers) may also be employed in order to give polyethylene copolymer.

Preferably the comonomer is an alpha-olefin having from 3 to 15 carbon atoms, preferably 4 to 12 carbon atoms and most preferably 4 to 6 carbon atoms.

Optionally, scavengers are added to the polymerization process. The present invention can be carried out in the presence of any suitable scavenger or scavengers. Scavengers are well known in the art.

Suitable scavengers include organoaluminum compounds having the formula: Al³(X³)ₙ(X⁴)₃₋ₙ, where (X³) is a hydrocarbyl having from 1 to about 20 carbon atoms; (X⁴) is selected from alkoxide or aryloxide, any one of which having from 1 to about 20 carbon atoms; halide; or hydride; and n is a number from 1 to 3, inclusive; or alkylaluminoxanes having the formula: R³₂Al¹O (R³Al¹O)ₘAl¹R³₂, wherein each R³ is independently selected from the group consisting of C₁₋₂₀ hydrocarbyl radicals and m is from 3 to 50. Some non-limiting preferred scavengers useful in the current invention include triisobutylaluminum, triethylaluminum, trimethylaluminum or other trialkylaluminum compounds.

The scavenger may be used in any suitable amount but by way of non-limiting examples only, can be present in an amount to provide a molar ratio of Al:M (where M is the metal of the organometallic compound) of from about 20 to about 2000, or from about 50 to about 1000, or from about 100 to about 500. Generally the scavenger is added to the reactor prior to the catalyst and in the absence of additional poisons and over time declines to 0, or is added continuously.

Optionally, the scavengers may be independently supported. For example, an inorganic oxide that has been treated with an organoaluminum compound or alkylaluminoxane may be added to the polymerization reactor.

The polyethylene resins used in this invention are further characterized by having a very high molecular weight. This is quantified by the requirement that the resins have a very low High Load Melt Index (HLMI), as measured by ASTM 1238 at 190° C. using a 21.6 kg weight. More specifically, the resins have a HLMI of less than 10 g/10 minutes, especially from 0.5 to 8 g/10 minutes. Polyethylene resin that is prepared with a Cr catalyst also typically contains long chain branching (LCB). This combination of properties (i.e. high molecular weight/low HLMI and the presence of LCB) can disrupt the crystallinity of the resin as it freezes from melt and, in general, this combination of properties has been observed to reduce the effectiveness of some nucleating agents.

The polyethylene resin that is used in this invention is additionally characterized by having a comonomer (i.e. homopolymers are excluded) and by having a density of from 0.944 to 0.955 g/cc.

The polyethylene resin may be unimodal or bimodal. The use of bimodal/multimodal resins for blow molding processes is being proposed/recommended at an increasing rate as such resins become commercially available. However, a disadvantage of bimodal/multimodal resins is that they can be comparatively expensive. One advantage of the present invention is that high quality parts can be made at high rates when using a comparatively inexpensive monomodal resin.

### Part B: Nucleating Agents

The nucleating agents used in the present invention must be present in amounts of from 100 to 5,000 parts per million by weight.

The use of larger amounts of nucleating agent is not contemplated. For example, large amounts of talc are often used as a filler in polyethylene compositions but these large amounts (i.e. weight percentages, as opposed to parts per million) typically have an adverse effect on the properties of the molded part (especially impact strength). If talc is used as a nucleating agent, a small particle size (from 0.5 to 5 microns, especially from 0.5 to 2 microns) is preferred. For example, the use of 2,000-3,000 parts by weight of small particle size talc (average particle size of 0.8 microns, sold under the trademark MICROTUFF® AG609) has been observed to favorably reduce the crystallization half time of the Cr catalyzed ethylene copolymer used in this invention and hence is suitable for use as a nucleating agent. Coated talcs (i.e. talcs which contain a coating such as a fatty acid; a polyether or a polysiloxane) are also suitable. However, the preferred nucleating agent may be “end use specific” as different nucleating agents can affect certain properties (such as color and impact strength) which might be important for certain end uses such as IBCs and less important for others such as toys. In addition, it is desirable for the nucleating agent to be sufficiently stable and robust to allow for multiple heat cycles because this allows the use of scrap/malformed parts to be recycled for the production of more parts. The examples illustrate the use of a commercially available nucleating agent, namely, HYPERFORM® HPN 20E (which is believed to be the calcium salt of hexahydrophthalic acid in combination with a dispersing agent which is believed to be zinc stearate).

The term “nucleating agent”, as used herein, is meant to convey its conventional meaning to those skilled in the art of preparing nucleated polyolefin compositions, namely an additive that changes the crystallization behavior of a polymer as the polymer melt is cooled.

Nucleating agents are widely used to prepare classified polypropylene and to improve the molding characteristics of polyethylene terphlate (PET). They are less commonly used to nucleate polyethylene.

A review of nucleating agents is provided in U.S. Pat. Nos. 5,981,636; 6,465,551 and 6,599,971, the disclosures of which are incorporated herein by reference.

There are two major families of nucleating agents, namely “inorganic” (e.g. small particulates, especially talc or calcium carbonate) and “organic”.

It is known to use talc and or calcium carbonate as fillers for polyethylene resin compositions that are used in blow molding operations. However, this use is in amounts that far exceed the upper limit required for nucleation (about 5,000 parts per million) and such large amounts can cause other problems (such as unwanted color and/or a deterioration in physical properties).

It is also known that one of the blue pigments that is used in blow molding (especially to prepare blue plastic drums) can nucleate polyethylene. However, this blue pigment is also used in amounts that far exceed the amount to induce nucleation (and, obviously, the use of this pigment is not desirable for the preparation of parts having a color other than blue).

Examples of conventional organic nucleating agents which are commercially available and in widespread use as polypropylene additives are the dibenzylidene sorbital esters (such as the products sold under the trademark MILLAD® 3988 by Milliken Chemical and IRGASTAB® 287 by Ciba Specialty Chemicals).

High performance, organic nucleating agents which have a very high melting point have recently been developed. These nucleating agents are sometimes referred to as “insoluble organic” nucleating agents—to generally indicate that they do not melt disperse in polyethylene during polyolefin extrusion operations. In general, these insoluble organic nucleating agents either do not have a true melting point (i.e. they decompose prior to melting) or have a melting point greater than 300° C. or, alternatively stated, a melting/decomposition temperature of greater than 300° C.

The amount of nucleating agent used is comparatively small-especially from 100 to 3,000 parts by million per weight (based on the weight of the polyethylene) so it will be appreciated by those skilled in the art that some care must be taken to ensure that the nucleating agent is well dispersed. It is preferred to add the nucleating agent in finely divided form (less than 50 microns, especially less than 10 microns) to the polyethylene to facilitate mixing. This type of “physical blend” (i.e. a mixture of the nucleating agent and the resin in solid form) is generally preferable to the use of a “masterbatch” of the nucleator (where the term “masterbatch” refers to the practice of first melt mixing—the nucleator, in this case—with a small amount of High Density Polyethylene (HDPE) resin-then melt mixing the “masterbatch” with the remaining bulk of the HDPE resin).

Examples of high performance organic nucleating agents (or “nucleators”) which may be suitable for use in the present invention include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophthalic acid structure (or “HHPA” structure) as disclosed in U.S. Pat. No. 6,599,971 (Dotson et al., to Milliken); and phosphate esters, such as those disclosed in U.S. Pat. No. 5,342,868 and those sold under the trade names NA-11 and NA-21 by Asahi Denka Kogyo. Preferred nucleators are cylic dicarboxylates and the salts thereof, especially the divalent metal or metalloid salts, (particularly, calcium salts) of the HHPA structures disclosed in U.S. Pat. No. 6,599,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,599,971. A preferred example is 1,2-cyclohexanedicarboxylicacid, calcium salt (CAS registry number 491589-22-1).

### Part C: Other Additives

The HDPE may also contain other conventional additives, especially primary antioxidants, secondary antioxidants and Hindered Amine Light Stabilizers. Primary antioxidants include (but are not limited to) phenolics, hydoxyl amines (and amine oxides) and lactones.

### Phenolic Antioxidants

### Alkylated Mono-Phenols

For example, 2,6-di-tert-butyl-4-methylphenol; 2-tert-butyl-4,6-dimethylphenol; 2,6-di-tert-butyl-4-ethylphenol; 2,6-di-tert-butyl-4-n-butylphenol; 2,6-di-tert-butyl-4-isobutylphenol; 2,6-dicyclopentyl-4-methylphenol; 2-(.alpha.-methylcyclohexyl)-4,6 dimethylphenol; 2,6-di-octadecyl-4-methylphenol; 2,4,6,-tricyclohexyphenol; and 2,6-di-tert-butyl-4-methoxymethylphenol.

### Alkylated Hydroquinones

For example, 2,6di-tert-butyl-4-methoxyphenol; 2,5-di-tert-butylhydroquinone; 2,5-di-tert-amyl-hydroquinone; and 2,6diphenyl-4-octadecyloxyphenol.

### Hydroxylated Thiodiphenyl Ethers

For example, 2,2′-thio-bis-(6-tert-butyl-4-methylphenol); 2,2′-thio-bis-(4-octylphenol); 4,4′thio-bis-(6-tertbutyl-3-methylphenol); and 4,4′-thio-bis-(6-tert-butyl-2-methylphenol).

### Alkylidene-Bisphenols

For example, 2,2′-methylene-bis-(6-tert-butyl-4-methylphenol); 2,2′-methylene-bis-(6-tert-butyl-4-ethylphenol); 2,2′-methylene-bis-(4-methyl-6-(alpha-methylcyclohexyl)phenol); 2,2′-methylene-bis-(4-methyl-6-cyclohexylphenol); 2,2′-methylene-bis-(6-nonyl-4-methylphenol); 2,2′-methylene-bis-(6-nonyl-4methyl phenol); 2,2′-methylene-bis-(6-(alpha-methylbenzyl)-4-nonylphenol); 2,2′-methylene-bis-(6-(alpha, alpha-dimethylbenzyl)-4-nonyl-phenol); 2,2′-methylene-bis-(4,6-di-tert-butylphenol); 2,2′-ethylidene-bis-(6-tert-butyl-4-isobutylphenol); 4,4′methylene-bis-(2,6-di-tert-butylphenol); 4,4′-methylene-bis-(6-tert-butyl-2-methylphenol); 1,1-bis-(5-tert-butyl-4-hydroxy-2-methylphenol)butane 2,6-di-(3-tert-butyl-5-methyl-2-hydroxybenzyl)-4-methylphenol; 1,1,3-tris-(5-tert-butyl-4-hydroxy-2-methylphenyl)butane; 1,1-bis-(5-tert-butyl-4-hydroxy2-methylphenyl)-3-dodecyl-mercaptobutane; ethyleneglycol-bis-(3,3,-bis-(3′-tert-butyl-4′-hydroxyphenyl)-butyrate)-di-(3-tert-butyl-4-hydroxy-5-methylpenyl)-dicyclopentadiene; di-(2-(3′-tert-butyl-2′hydroxy-5′methylbenzyl)-6-tert-butyl-4-methylphenyOterephthalate; and other phenolics such as monoacrylate esters of bisphenols such as ethylidiene bis-2,4-di-t-butylphenol monoacrylate ester.

### Benzyl Compounds

For example, 1,3,5-tris-(3,5-di-tert-butyl-4-hydroxybenzyl)-2,4,6-trimethylbenzene; bis-(3,5-di-tert-butyl-4-hydroxybenzyl)sulfide; isooctyl 3,5-di-tert-butyl-4-hydroxybenzyl-mercaptoacetate; bis-(4-tert-butyl-3hydroxy-2,6-dimethylbenzyl)dithiol-terephthalate; 1,3,5-tris-(3,5-di-tert-butyl-4,10 hydroxybenzyl)isocyanurate; 1,3,5-tris-(4-tert-butyl-3-hydroxy-2,6-dimethylbenzyl)isocyanurate; dioctadecyl 3,5-di-tert-butyl-4-hydroxybenzylphosphonate; calcium salt of monoethyl 3,5-di-tertbutyl-4-hydroxybenzylphosphonate; and 1,3,5-tris-(3,5-dicyclohexyl-4-hydroxybenzyl)isocyanurate.

### Acylaminophenols

For example, 4-hydroxy-lauric acid anilide; 4-hydroxy-stearic acid anilide; 2,4-bis-octylmercapto-6-(3,5-tert-butyl-4-hydroxyanilino)-s-triazine; and octyl-N-(3,5-di-tert-butyl-4-hydroxyphenyl)-carbamate.

Esters of beta-(5-tert-butyl-4-hydroxy-3-methylphenyl)-propionic acid with Monohydric or Polyhydric Alcohols

For example, methanol; diethyleneglycol; octadecanol; triethyleneglycol; 1,6-hexanediol; pentaerythritol; neopentylglycol; tris-hydroxyethyl isocyanurate; thidiethyleneglycol; and dihydroxyethyl oxalic acid diamide.

Amides of beta-(3,5-di-tert-butyl-4hydroxyphenol)-propionic acid

For example, N,N′-di-(3,5-di-tert-butyl-4-hydroxyphenylpropionyl)-hexamethylendiamine; N,N′-di-(3,5-di-tert-butyl-4-hydroxyphenylpropionyl)trimethylenediamine; and N,N′-di(3,5-di-tert-butyl-4-hydroxyphenylpropionyl)-hydrazine.

### Hydroxylamines and Amine Oxides

For example, N,N-dibenzylhydroxylamine; N,N-diethylhydroxylamine; N,N-dioctylhydroxylamine; N,N-dilaurylhydroxylamine; N,N-ditetradecylhydroxylamine; N,N-dihexadecylhydroxylamine; N,N-dioctadecylhydroxylamine; N-hexadecyl-N-octadecyl hydroxylamnine; N-heptadecyl-N-octadecylhydroxylamine; and N,N-dialkylhydroxylamine derived from hydrogenated tallow amine. The analogous amine oxides (as disclosed in U.S. Pat. No. 5,844,029, Prachu et al.) are also meant to be included by the definition of hydroxylamine.

### Lactones

The use of lactones such as benzofuranone (and derivatives thereof) or indolinone (and derivatives thereof) as stabilizers is described in U.S. Pat. No. 4,611,016.

### Secondary Antioxidants

Secondary antioxidants include (but are not limited to) phosphites, diphosphites and phosphonites. Non-limiting examples of suitable aryl monophosphites follow. Preferred aryl monophosphites are indicated by the use of trademarks in square brackets.

Triphenyl phosphite; diphenyl alkyl phosphites; phenyl dialkyl phosphites; tris(nonylphenyl) phosphite [WESTON® 399, available from Addivant™]; tris(2,4-di-tert-butylphenyl) phosphite [IRGAFOS® 168, available from Ciba Specialty Chemicals Corp.]; and bis(2,4-di-tert-butyl-6-methylphenyl) ethyl phosphite [IRGAFOS 38, available from Ciba Specialty Chemicals Corp.]; and 2,2′,2″-nitrilo[triethyltris(3,3′5,5′-tetra-tert-butyl-1,1′-biphenyl-2,2′-diyl) phosphite [IRGAFOS 12, available from Ciba Specialty Chemicals Corp.].

### Diphosphite

As used herein, the term diphosphite refers to a phosphite stabilizer which contains at least two phosphorus atoms per phosphite molecule (and, similarly, the term diphosphonite refers to a phosphonite stabilizer which contains at least two phosphorus atoms per phosphonite molecule).

Non-limiting examples of suitable diphosphites and diphosphonites follow: distearyl pentaerythritol diphosphite, diisodecyl pentaerythritol diphosphite, bis(2,4 di-tert-butylphenyl) pentaerythritol diphosphite [ULTRANOX® 626, available from Addivant™]; bis(2,6-di-tert-butyl-4-methylpenyl) pentaerythritol diphosphite; bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tetrakis(2,4-di-tert-butylphenyl)4,4′-bipheylene-diphosphonite [IRGAFOS P-EPQ, available from Ciba] and bis(2,4-dicumylphenyl)pentaerythritol diphosphite [DOVERPHOS® 59228-T or DOVERPHOS S9228-CT].

PEPQ (CAS No 119345-01-06) is an example of a commercially available diphosphonite.

The diphosphite and/or diphosphonite are commonly used in amounts of from 200 ppm to 2,000 ppm, preferably from 300 to 1,500 ppm and most preferably from 400 to 1,000 ppm.

The use of diphosphites is preferred over the use of diphosphonites. The most preferred diphosphites are those available under the trademarks DOVERPHOS S9228-CT and ULTRANOX 626.

### Hindered Amine Light Stabilizers (HALS)

A hindered amine light stabilizer (HALS) is preferably included in the stabilizer package used in the present invention if the plastic part is intended for more than single/short term use.

HALS are well known to those skilled in the art.

When employed, the HALS is preferably a commercially available material and is used in a conventional manner and amount.

Commercially available HALS include those sold under the trademarks CHIMASSORB® 119; CHIMASSORB 944; CHIMASSORB 2020; TINUVIN® 622 and TINUVIN 770 from Ciba Specialty Chemicals Corporation, and CYASORB® UV 3346, CYASORB UV 3529, CYASORB UV 4801, and CYASORB UV 4802 from Cytec Industries. TINUVIN 622 is preferred. Mixtures of more than one HALS are also contemplated.

Suitable HALS include: bis (2,2,6,6-tetramethylpiperidyl)-sebacate; bis-5 (1,2,2,6,6-pentamethylpiperidyl)-sebacate; n-butyl-3,5-di-tert-butyl-4-hydroxybenzyl malonic acid bis(1,2,2,6,6,-pentamethylpiperidyl)ester; condensation product of 1-hydroxyethyl-2,2,6,6-tetramethyl-4-hydroxy-piperidine and succinic acid; condensation product of N,N′-(2,2,6,6-tetramethylpiperidyl)-hexamethylendiamine and 4-tert-octylamino-2,6-dichloro-1,3,5-s-triazine; tris-(2,2,6,6-tetramethylpiperidyl)-nitrilotriacetate, tetrakis-(2,2,6,6-tetramethyl-4-piperidyl)-1,2,3,4butane-tetra-arbonic acid; and 1,1′(1,2-ethanediyl)-bis-(3,3,5,5-tetramethylpiperazinone).

### Part D: Blow Molding Process

The term “blow molding” as used herein is meant to refer to a well-known, commercially important process that is widely used to manufacture hollow plastic goods. In general, the process starts with a “pre-form” or “parison” of the plastic. The parison is clamped into the mold; heated and then stretched by directing a flow of gas (usually air) into the parison. The pressure from the gas forces the outer surface of the parison against the walls of the mold. The plastic is then cooled and removed from the mold.

While not wishing to be bound by theory, it is believed that the nucleating agent that is used in the present invention increases the rate at which the plastic part cools and/or induces a more consistent cooling/freezing pattern in the molded part (which thereby reduces the level of poorly formed or warped parts).

Blow molding is commercially used for the preparation of a wide variety of goods including small water bottles (having a volume of from about 500 ml to 2 liters); hollow toys; plastic drums (having a typical volume of from 150 to 250 liters) and intermediate bulk containers (which may have a volume of several thousand liters.

### Examples

### Part A: Preparation of a Cr Catalyzed Polyethylene

### 1. Catalyst Preparation

The catalyst used to prepare the polyethylene used in this example generally comprises a silyl chromate and an alkyl aluminum alkoxide that is supported on silica.

The silica support was a commercially available material that is old by W.R. Grace under the tradename D955 Silica. The support was calcined at 600° C. to reduce the level of surface hydroxyl groups in the silica.

The calcined silica was then slurried in hydrocarbon (isopentane) with silyl chromate -(Ph₃SiO)₂Cr₂O₂ (where Ph is phenyl)—at 45° C. for two hours in an amount that is sufficient to provide 0.25 weight % Cr (based on the weight of the silica). Dietylaluminum ethoxide (Et₂AlOEt) was then added at an Al/Cr mole ratio of 1.48/1) and the slurry was stirred for another 2.5 hours at 60° C. The hydrocarbon was then removed to provide a free flow powder having a light green color.

### 2. Gas Phase Polymerization

A catalyst prepared in the manner described in Part 1 above was used in a gas phase polymerization reactor to prepare ethylene-hexene copolymers having comparatively high molecular weight (as indicated by the High Load Melt Index, or HLMI, value of the copolymers).

Characteristics of a copolymer made in the manner described above follow.

Density (as determined by ASTM D1928)=0.946 g/cc

HLMI (as determined by ASTM 1238, at a temperature of 190° C., using a 21.6 kg load)=6 grams/10 minutes

Gel Permeation Chromatograph (GPC) characterizations were made in general accordance with ASTM D6474-99 to determine Mw, Mn (and Mw/Mn):

Mw=229,277

Mn=15,807

Mw/Mn=14.5

Mz=1,265,497

The GPC curve showed the copolymer to be unimodal. The GPC data shows that the Cr-catalyzed copolymer used in this example contains some very high molecular weight material.

### Nucleated Cr Catalyzed Resin

Conventional high density polyethylene that does not contain a high molecular weight fraction is, in general, comparatively easy to crystallize. This is reflected in low crystallization half times (which can be less than 10, and even less than 5 minutes). In contrast, the Cr catalyzed polyethylene used in this invention contains high molecular weight material and has a high crystallization half time (in excess of 20 minutes). The use of a nucleating agent reduces the crystallization half time, as shown below.

Crystallization half time is determined using a Differential Scanning calorimeter (DSC) as follows.

### Crystallization Half Time Method

The crystallization half time test was conducted on a Differential Scanning calorimeter (purchased from TA Instruments under the trademark Q2000). The polyethylene composition is initially heated to 150° C. at a rate of 20° C. per minute. The sample is then held at 150° C. for 10 minutes. At that time, the temperature is lowered to 125° C. at a cooling rate of 70° C. per minute. The sample is held at 125° C. for 80 minutes. The DSC instrument produces a curve which shows the exotherm of crystallization with time. The time at which one half of the heat of crystallization was generated is reported as the crystallization half time (in minutes). It should be noted that the temperature at which the sample is crystallized (i.e. 125° C. in the test method described above) can affect the crystallization half time. Accordingly, it is preferred to describe the test results as “crystallization half time (in minutes) as determined at a temperature of [the isothermal crystallization temperature]”.

Thus, for clarity, the result from the test method described above would be reported as “crystallization half time (in minutes), as determined at a temperature of 125° C.”.

The crystallization half time of a Cr catalyzed, ethylene copolymer having a HLMI of 6 g/10 minutes and a density of 0.946 g/cc was determined to be 42 minutes. This ethylene copolymer was prepared in general accordance with Part 1 (above) but this copolymer is “comparative” because it does not contain a nucleating agent.

Inventive compositions were then prepared by adding a nucleating agent to the above described Cr catalyzed resin. The nucleating agent is sold under the trademark HPN® 20 E by Milliken Chemicals. HPN 20E is reported to consist of the calcium salt of hexahydrophthalic acid (CAS Registry number 491589-22-1) and may also contain an optional dispersing agent, such as zinc stearate. The nucleating agent was added in amounts of 400 parts per million; based on the weight of the polyethylene (ppm) and 1200 ppm. The crystallization half time of these nucleated compositions were measured and found to be 37 and 29 minutes, respectively (reductions of 12% and 31% in comparison to the non nucleated control).

### Part II: Preparation of Blow Molded Parts

### Blow Molding Equipment

### General

This machine is a continuous type blow molder with a servo valve for die pin movement. The blow molder is used for the production of blow molded bottles.

### Mold

The mold is a standard bottle design. The cavity wall is all aluminum casting with beryllium copper neck and bottom pinch-off inserts. The mold is internally cooled by a portable chiller using a water glycol solution. The mold closing system uses a traditional mold clamping toggle system. Clamp pressure is 6 MPa/870 psi. Die tooling used is a converging die pin and hardened heavy wall mandrel for production of 16 oz. bottles.

### Parison Programmer

The parison programmer on the blow molder works on a variable voltage. It sends an adjusted voltage to move the die pin up or down to adjust the parison thickness. The weight control feature is used to lengthen or shorten the parison. Two other adjustments are weight range and profile range. Weight range allows the operator to change calibration voltage without affecting the calibration of the program panel (i.e. programmer) vice versa for the profile range.

Standard operating conditions for the blow molder are provided in Table 1.

TABLE 1
Standard Blow Molding Operating Conditions
Temp Profile - all bottle types
on Fischer Blow Molder (Temps Degrees F.)

| Zone | |
|---|---|
| Barrel 1 | 370 |
| Barrel 2 | 380 |
| Barrel 3 | 390 |
| Adapter | 400 |
| Head 1 | 400 |
| Head 2 | 400 |
| Die 1 | 400 |
| Melt temp | 410 ± 10 |
| Barrel Cooling Temp | 145° F. |
| Mold (coolant) Temp | 45° F. ± 5° F. |

Bottle Parameters: Squat Bottle 16 oz

| | |
|---|---|
| Parameter | Heavy Walled |
| | Squat |
| Bottle Wt (Optimum-DAR¹) | 75 g |
| Thickness (nom) | 0.070″ |
| Thickness (min) | 0.050″(Bottom corner) |
| Tooling | 0.570″ OD converging mandrel |
| | c/w 0.830″ ID bushing. |
| Blow Stem | 1.170″ OD |
| Blow Nozzle | 0.750″ OD |
| Blow Pressure | 50 PSI |
| Output | Resin Dependent; Target |
| | 40 lb./hour ± 5 lb./hr |
| Tail Width | Resin Dependent |
| Tail Length | 3.5 cm |

### Preparation of Blow Molded Parts

### Preparation of Blow Molded Bottles

The blow molding machine described above was used to prepare bottles from a nucleated ethylene copolymer as described in Part A above.

The Cr catalyzed ethylene copolymer had a density of 0.946 g/cc; a HLMI of 6 grams per 10 minutes and contained 1200 parts per million by weight of the nucleating agent sold under the trademark HYPERFORM HPN 20E. The comparative “base” copolymer (without the nucleating agent) had a crystallization half time (measured at 125° C.) of 42 minutes; the inventive composition (containing a combination of the comparative base copolymer plus 1200 ppm of HPN 20E nucleating agent) had a crystallization half time of 29 minutes (which is 31% faster than that of the comparative base resin).

In addition, both the comparative and inventive resin composition contained a conventional primary antioxidant, secondary antioxidant and HALS.

Bottles were molded at a total cycle time of 39 seconds using both of the comparative base copolymer and the inventive composition. The aiming point for the weight of the parison was 76 grams with a range of 75 to 77 g considered to be acceptable.

The parison was heated to 210° C. at the start of the process.

Bottles were molded over a period of at least one hour. At this cycle time, approximately 90% of the bottles that were formed from the comparative resin were malformed. The bottles may have contained too little or too much resin (as measured by weight) or were obviously misshaped. In contrast, only 10-15% of the bottles that were formed from the inventive composition were malformed (again, as determined by low weight; high weight or a misshaped article).

The cycle time was further reduced to 35 seconds. At this cycle time, the comparative composition was not observed to successfully produce any satisfactory bottles over the course of one hour but the inventive composition provided a success rate of about 70%.

### Composition Stability

The ethylene copolymer compositions used in the above examples (both the comparative and inventive compositions were subjected to a “multi-pass” study in which the compositions were subjected to 5 separate cycles of being melted and sheared at a temperature of over 200° C. in order to determine whether the nucleating agent had any deleterious effects on the ethylene copolymer after the multiple heat/and shear cycles. The following tests were conducted:

1) melt flow ratio (12/12);

2) instrumented impact energy;

3) maximum load; and

4) color.

The resins (comparative and inventive) both were observed to have minor deteriorations in each of the above listed parameters. However, the presence of the nucleating agent did not have a significant impact (adverse or beneficial) on these properties.

Accordingly, the nucleated resin compositions are potentially suitable for reground/recycle in the same manner and amount as the non nucleated resin. This allows the malformed parts to be ground, mixed with new (or “virgin” resin) and then used to prepare “prime” parts.

### INDUSTRIAL APPLICABILITY

An improved blow molding process is provided by molding a composition comprising a chromium catalyzed polyethylene resin and a nucleating agent. The process is especially suitable for the preparation of bulk containers for liquids and particulate solids.

1. A blow molding composition comprising:
A) a chromium catalyzed ethylene copolymer having
i) a high load melt index, as measured by ASTM 1238 at 190° C. using a 21.6 kg load, of from 2 to 10 grams/10 minutes;
ii) a density of from 0.944 to 0.955 g/cc;
iii) a crystallization half time of greater than 20 minutes when measured at 125° C. and in the absence of a nucleating agent; and
B) from 100 to 5000 ppm of nucleating agent,
wherein the crystallization half time of the composition containing the nucleating agent is at least 10% lower than the crystallization half time of the non nucleated copolymer (A).

2. The composition according to claim 1, wherein the non nucleated ethylene copolymer (A) has a crystallization half time of from 21 to 50 minutes.

3. The composition according to claim 1, wherein the non nucleated ethylene copolymer has a high load melt index of from 3 to 6 grams per 10 minutes.

4. The composition according to claim 1, wherein said nucleating agent comprises the calcium salt of hexahydrophthalic acid.

5. The composition according to claim 1, wherein said ethylene copolymer is unimodal.

6. A blow molded article prepared from the composition of claim 1.

7. A blow molded article according to claim 5, wherein said blow molded article is selected from the groups consisting of bottles, drums, intermediate bulk containers and toys.

8. A blow molded article according to claim 6, wherein said ethylene copolymer is unimodal.

9. A process to prepare a blow molded article, wherein said process comprising:
I) preparing a parison from a blow molding composition comprising
A) a chromium catalyzed ethylene copolymer having
i) a high load melt index, as measured by ASTM 1238 at 190° C. using a 21.6 kg load, of from 2 to 10 grams/10 minutes;
ii) a density of from 0.944 to 0.955 g/cc;
iii) a crystallization half time of greater than 20 minutes when measured at 125° C. and in the absence of a nucleating agent; and
B) from 100 to 5000 ppm of nucleating agent,
wherein the crystallization half time of the composition containing the nucleating agent is at least 10% lower than the crystallization half time of the non nucleated copolymer (A).
II) subjecting said parison to a blow molding process.

10. The process according to claim 9, wherein said nucleating agent comprises the calcium salt of hexahydrophthalic acid.

11. The process according to claim 9, wherein said ethylene copolymer is unimodal.

12. The process according to claim 9, wherein said parison is heated to a temperature of from 180° C. to 300° C.

13. The process according to claim 9, wherein said process produces a blow molded article selected from the group consisting of bottles, drums, intermediate bulk containers and toys.

14. The process according to claim 9, wherein the number of malformed parts is reduced in comparison to a comparative blow molding process undertaken under the same blow molding conditions but in the absence of said nucleating agent.
